(19) United States
(12) Patent Application Publication
(10) Pub. No.: US 2009/0002900 A1
(43) Pub. Date: Jan. 1, 2009

(54) SYSTEM AND METHOD FOR PROTECTING ELECTRONIC DEVICES

(75) Inventor: Tsung-Je CHIU, Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/967,003

(22) Filed: Dec. 29, 2007

(30) Foreign Application Priority Data
Jun. 29, 2007 (CN) 200710200966.X

(51) Int. Cl. H02H 3/00

(52) U.S. Cl. 361/1

(57) ABSTRACT

A system for protecting an electronic devices includes a memory unit, a reading unit, a judging unit, an extra action unit, and a writing unit. The memory unit is configured for storing a variable, the variable having a first value representing the last power off of the electronic device being abnormal and a second value representing the last power off of the electronic device being normal. The reading unit is configured for reading the variable stored in the memory unit in the power-on process of the electronic device. The judging unit is configured for judging whether the last power off of the electronic device is abnormal according to the value of the variable. The extra action unit is configured for protecting the electronic device by executing an extra action, if the last power off of the electronic device was abnormal. The writing unit is used for changing the variable.

### TECHNICAL FIELD

The present invention relates to systems and methods for protecting electronic devices and, particularly, to a system and a method for protecting electronic devices from being burnt out because of last power off of the electronic device being abnormal.

### DESCRIPTION OF RELATED ART

Electronic devices are becoming more and more popular and thus more widely used. These electronic devices include computing devices such as notebook/portable computers and personal digital assistants (PDAs), communication devices such as wireless telephones, and media devices, such as CDs, DVDs, and MP3 players.

Some electronic devices, such as projectors, generate a lot of heat when they are working and need to be cooled for a time even after shutdown. These electronic devices are normally cooled by fans after being powered off normally, but may not be cooled if the electronic is powered off abnormally (such as when power is momentarily lost), which can result in damage to the electronic devices.

What is needed, therefore, is a system and a method for protecting electronic devices from being damage because of last power off of the electronic device being abnormal.

### SUMMARY

In accordance with one present embodiment, a system for protecting an electronic devices includes a memory unit, a reading unit, a judging unit, an extra action unit, and a writing unit. The memory unit is configured for storing a variable, the variable having a first value representing the last power off of the electronic device being abnormal and a second value representing the last power off of the electronic device being normal. The reading unit is configured for reading the variable stored in the memory unit in the power-on process of the electronic device. The judging unit is configured for judging whether the last power off of the electronic device is abnormal according to the value of the variable. The extra action unit is configured for protecting the electronic device by executing an extra action, if the last power off of the electronic device was abnormal. The writing unit is used for setting the value of the variable as the first value in the power-on process of the electronic device after the reading unit reading the variable, and setting the value of the variable as the second value in a normal power-off process of the electronic device.

### BRIEF DESCRIPTION OF THE DRAWING

Many aspects of the present system and method for protecting electronic devices can be better understood with reference to the following drawings. The components in the drawing are not necessarily drawn to scale, the emphasis instead being placed upon clearly illustrating the principles of the present projector.

FIG. 1 is a schematic, functional block diagram of a system for protecting an electronic devices according to a present embodiment.

FIG. 2 is a flow chart of a method for protecting electronic devices according to a present embodiment.

### DETAILED DESCRIPTION OF THE EMBODIMENTS

Embodiments of the present invention will now be described in detail below, with reference to the drawings.

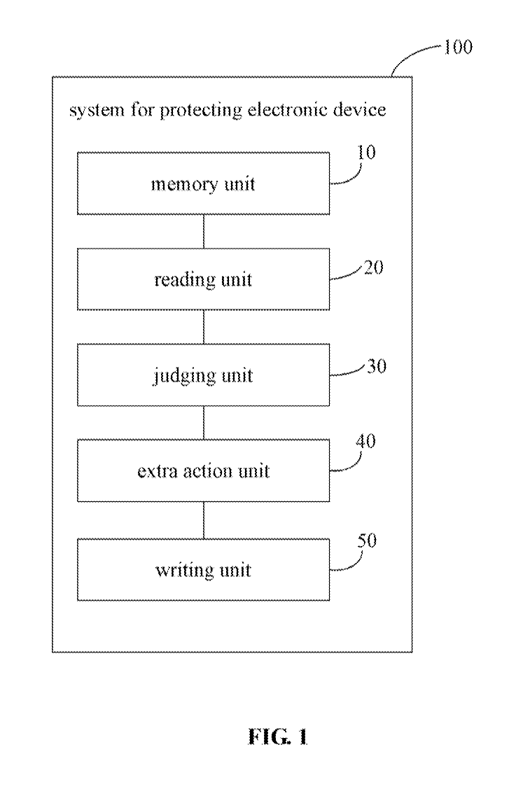

Referring to FIG. 1, a system 100 for protecting an electronic device includes a memory unit 10, a reading unit 20, a judging unit 30, an extra action unit 40, and a writing unit 50. The system 100 is used for protecting an electronic device from being damaged because of last power off of the electronic device being abnormal. The electronic device can be a computer, a projector and so on. In the present embodiment, the electronic device is a projector.

The memory unit 10 is configured for storing a variable which can be set at a first value such as 0 or a second value such as 1. The first value represents that the last power off of the electronic device was abnormal, and the second value represents that the last power off of the electronic device was normal.

The reading unit 20 is configured for reading the variable stored in the memory unit 10 in the power-on process of the electronic device.

The judging unit 30 is configured for judging whether the last power off of the electronic device was abnormal according to the value of the variable in the power-on process of the electronic device. If the value of the variable is equal to the first value, the judging unit 30 will judge that the last power off of the electronic device was abnormal. If the value of the variable is equal to the second value, the judging unit 30 will judge that the last power off of the electronic device was normal.

If the judging unit 30 judges that the last power off of the electronic device was abnormal, the extra action unit 40 will be activated for protecting the electronic device by executing an extra action before the electronic device can work normally. The extra action can be, for example, an extra cooling and so on. If the judging unit 30 judges that the last power off of the electronic device was normal, the electronic device will work normally without activating the extra action unit 40.

The writing unit 50 is configured for changing the value of the variable stored in the memory unit 10. The writing unit 50 can set the value of the variable as the first value in the power-on process of the electronic device after the reading unit 20 reads the variable, and set the value of the variable as the second value in a normal power-off process of the electronic device the value of the variable is kept unchanged in an abnormal power-off process of the electronic device. Therefore, if the electronic device is powered off normally, the value of the variable will be the second value when the electronic device is powered on the next time. If the electronic device is powered off abnormally, the value of the variable will be the first value when the electronic device is powered on the next time.

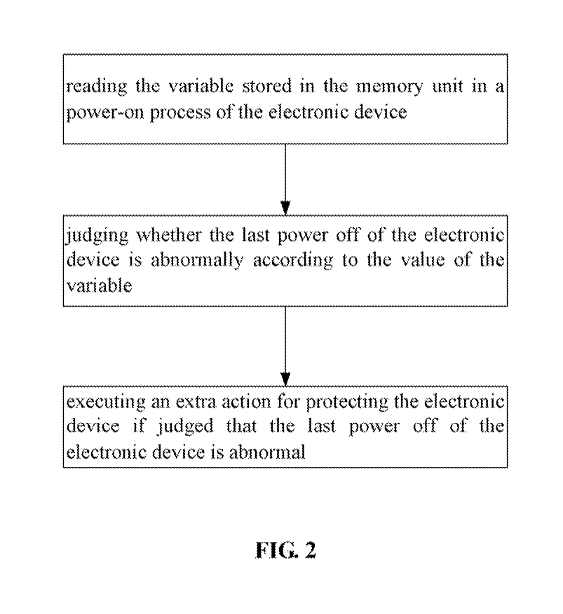

Referring to FIG. 2, a method for protecting an electronic device is also provided. The method includes the steps of: reading the variable stored in the memory unit 10 in the power-on process of the electronic device; judging whether the last power off of the electronic device was abnormal according to value of the variable; executing an extra action for protecting the electronic device if the last power off of the electronic device was abnormal.

The variable can be set at a first value or a second value. The first value represents that the last power off of the electronic device was abnormal, and the second value represents that the last power off of the electronic device was normal. The value of the variable is set as the first value in the power-on process of the electronic device after the reading unit 20 reads the variable, and set as the second value in a normal power-off process of the electronic device.

It is noted that the extra action executed is not limited to a cooling action but may encompass other actions as well such system diagnostics, network reconnection, generating a power interrupt report etc.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A system for protecting an electronic device comprising:
a memory unit for storing a variable, the variable having a first value representing the last power off of the electronic device being abnormal and a second value representing the last power off of the electronic device being normal;
a reading unit for reading the variable stored in the memory unit in the power-on process of the electronic device;
a judging unit for judging whether the last power off of the electronic device is abnormal according to the value of the variable;
an extra action unit for protecting the electronic device by executing an extra action, if the last power off of the electronic device was abnormal; and
a writing unit for setting the value of the variable as the first value in the power-on process of the electronic device after the reading unit reading the variable, and setting the value of the variable as the second value in a normal power-off process of the electronic device.

2. The system as claimed in claim 1, wherein the first value is 0 and the second value is 1.

3. The system as claimed in claim 1, wherein the extra action unit is configured for cooling a heat-generating component of the electronic device.

4. A method for protecting electronic device, the electronic device including a memory unit for storing a variable, the variable has a first value representing the last power off of the electronic device being abnormal and a second value representing the last power off of the electronic device being normal, comprising:
reading the variable stored in the memory unit in a power-on process of the electronic device;
judging whether the last power off of the electronic device is abnormally according to the value of the variable;
executing an extra action for protecting the electronic device if judged that the last power off of the electronic device is abnormal.

5. The method as claimed in claim 4, wherein the value of the variable is set as the first value in the power-on process of the electronic device after the reading unit reading the variable, and set as the second value in a normal power-off process of the electronic device.

6. The method as claimed in claim 4, further comprising using the electronic device normally without executing an extra action, if judged that the last power off of the electronic device is normal.

7. The method as claimed in claim 4, wherein the extra action is executed before the electronic device works.

8. The method as claimed in claim 5, wherein the value of the variable is kept unchanged in an abnormal power-off process of the electronic device.
